(19) United States
(12) Patent Application Publication
(10) Pub. No.: US 2012/0139261 A1
(43) Pub. Date: Jun. 7, 2012

(54) WAVE ENERGY CONVERSION SYSTEM

(76) Inventors: William Dick, Co. Carlow (IE); Carlos Villegas, Dublin (IE)

(21) Appl. No.: 13/321,444

(22) PCT Filed: May 13, 2010
(86) PCT No.: PCT/EP10/56629

§ 371 Date: Feb. 16, 2012

(30) Foreign Application Priority Data
May 13, 2009 (GB) 0908197.7

(51) Int. Cl. F03B 13/16; H02K 7/116

(52) U.S. Cl. 290/1 C; 290/42

(57) ABSTRACT

A wave energy conversion system is described. The system comprises a wave energy absorber for absorbing wave energy. At least one switched reluctance machine is driven by the wave energy absorber for converting mechanical energy to electrical energy. The switched reluctance machine has a generating mode and a motoring mode. A sensing means is provided for sensing an operating parameter generated by the wave energy absorber. A control means is co-operable with the sensing means for controlling the mode of the switched reluctance machine in response to the sensed operating parameter.

### FIELD OF THE INVENTION

The present invention relates to a wave energy conversion system. In particular the present invention relates to a wave energy conversion system which includes a mechanical energy converter which has a generating mode for providing power and a motoring mode for extracting power.

### BACKGROUND

Wave energy conversion systems are known in the art. Examples of such systems include those described in patents EP1439306, EP1295031 and EP1036274 of which the present applicant is the proprietor. Such systems are usefully deployed in a maritime environment and generate useful power from wave motion.

Such wave energy conversion systems employ a wave energy absorber, a hydraulic/pneumatic circuit and a power generator. Wave energy is absorbed by the wave energy absorber which pumps oil through the hydraulic/pneumatic circuit. The pump action causes a rotary element of the power generator to rotate thereby translating rotational energy into electrical energy. The hydraulic/pneumatic circuit is coupled between the wave energy absorber and the power generator and acts as an intermediary control means. The hydraulic/pneumatic circuit is complex. The absorbed mechanical energy is first converted to hydraulic/pneumatic energy, which is then converted to electrical energy which results in a relatively inefficient conversion process as the conversion from mechanical energy to electrical is not direct. The operating parameters of the hydraulic/pneumatic circuit may be changed in response to changes in the prevailing ocean conditions. However, the hydraulic/pneumatic circuit is unable to react rapidly enough to these changes due to the inherent characteristics of such circuits.

There is therefore a need for a wave energy conversion system which is adaptable to varying wave regimes and more efficient in converting mechanical forces to useful power.

### SUMMARY

These and other problems are addressed by a wave energy conversion system which includes a mechanical energy converter which has a generating mode and a motoring mode.

Accordingly, a first embodiment provides a wave energy conversion system as detailed in claim 1. Advantageous embodiments are provided in the dependent claims.

These and other features will be better understood with reference to the followings Figures which are provided to assist in an understanding of the teaching of the application.

### BRIEF DESCRIPTION OF THE DRAWINGS

The present invention will now be described with reference to the accompanying drawings in which:

FIG. 1 is a diagrammatic view of a wave energy conversion system.

FIG. 2 is a diagrammatic view of a detail of the mechanical energy converter of FIG. 1.

FIG. 3 is an inductance profile and force generation profile for the mechanical energy converter of FIG. 1, in both motoring and generating modes.

FIG. 4 is a schematic circuit diagram of a control circuit.

FIG. 5 is a diagrammatic illustration of the circuit of FIG. 4 with transistors Ti and T₂ switched on.

FIG. 6 is a diagrammatic illustration of the circuit of FIG. 4 with transistors Ti and T₂ switched off.

FIG. 7 is a diagrammatic view of another wave energy conversion system.

FIG. 8 is a diagrammatic view of a distributed electrical network which includes a plurality of the systems of FIG. 1.

FIG. 9 is a diagrammatic view of another wave energy conversion system.

FIG. 10 is a diagrammatic view of details of the wave energy conversion system.

FIG. 11 is a diagrammatic view of details of the wave energy conversion system.

FIG. 12 is a diagrammatic view of details of the wave energy conversion system.

FIG. 13 is a diagrammatic view of details of the wave energy conversion system.

### DETAILED DESCRIPTION OF THE DRAWINGS

The invention will now be described with reference to an exemplary system which is provided to assist in an understanding of the teaching of the invention.

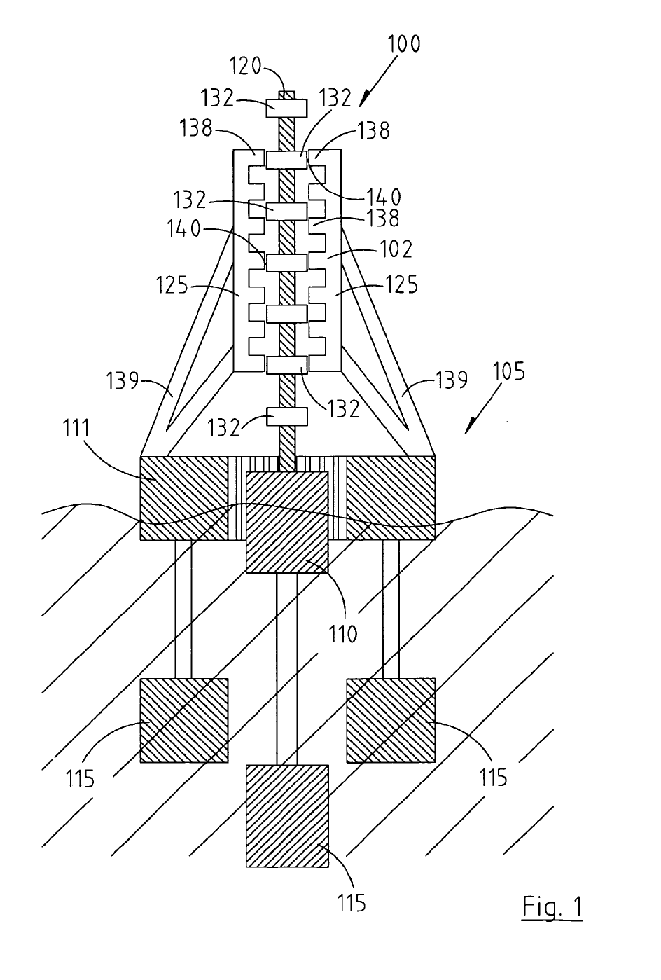

Referring initially to FIGS. 1 to 8 there is illustrated an exemplary wave energy conversion system 100 for harnessing wave energy. The system 100 comprises a power take-off device provided by a switched reluctance machine 102. In one exemplary embodiment the switched reluctance machine is a linear switched reluctance (LSR) generator configured to convert mechanical energy into electrical energy. The generator 102 is driven by a wave energy absorber 105. Before describing specifics of the generator 102 aspects of the wave energy absorber 105 will first be described. It will be understood that wave energy absorbers are known in the art, an example of which is shown in European Patent no. 1,295,031 of which the present applicant is the proprietor and replicated in FIG. 1 of the instant application. This exemplary wave energy absorber 105 comprises at least two devices (floats) 110, 111 which define a two body oscillator. While it is not intended to limit the teaching of the present invention to such a specific type of wave energy absorber, this specific absorber is described to assist in an understanding of how the parameters of a switched reluctance machine may be varied in response to changes in the prevailing wave conditions using power from an electrical grid such as an on-shore grid.

In this exemplary wave energy absorber, each of the two devices comprises a surface float and/or at least one submerged wave driven body 115 below the surface of the body of liquid. The outer surface float 111 provides an annular torus which surrounds the inner surface 110. Power take off linkages 139 are provided between the inner surface float 110 and the outer torus 111. By configuring each of the two devices 110, 111 to oscillate at different frequencies relative to one another in response to passing waves, relative movement between the at least two devices 110, 111 may be used to generate an energy transfer which may be harnessed by the linkages 139 between the at least two devices 110, 111. The linkages are coupled to the generator 102 which harnesses the mechanical energy generated by the wave energy absorber 105 and converts the mechanical energy into electrical energy.

In one arrangement which may be usefully employed within the context of the present teaching, the generator 102 is an LSR generator and is directly coupled to the wave energy absorber 105. The generator 102 comprises a translating member 120 of electrical steel which is moveable axially and intermediate to a pair of spaced apart stator members 125 also of electrical steel. The translating member 120 includes first and second sets of teeth 132 of rectangular cross section on its respective opposite sides which define translator poles. Each stator member 125 includes teeth 138 on one side thereof of rectangular cross section which define stator poles. The respective sides of the translating member 120 are associated with the corresponding stator members 125 such that the translator poles 132 and the stator poles 138 define opposing pole arrangements. The translating member 120 is operably coupled to the wave driven body 115 via linkages and is axially moveable along rails (not shown) such that the translating member 120 reciprocates in tandem with the oscillating wave driven body 115. The opposing pole arrangements are dimensioned such that air gaps 140 exist between the translator poles 132 and the stator poles 138. The translating member 120 is coupled to the inner surface float 110, and each stator member 125 is coupled to the annular outer surface float 111.

Copper coils 141 as illustrated in FIG. 4 are wound around the stator poles 138. The sequential energisation of these poles creates a magnetic field and a steady aligning force between opposing stator poles 138 and translator poles 132. The translating member 120 moves against the steady aligning force thereby converting mechanical energy into electrical energy. The aligning force may be considered to be an operating characteristic of the generator 102. A person skilled in the art will appreciate that, in motoring operation, a forward electromagnetic force (forward EMF) is produced when electric current flowing in a coil 141 coincides with rising coil inductance. In generating operation, a backward electromagnetic force (back EMF) is produced when the coil 141 current coincides with falling coil inductance.

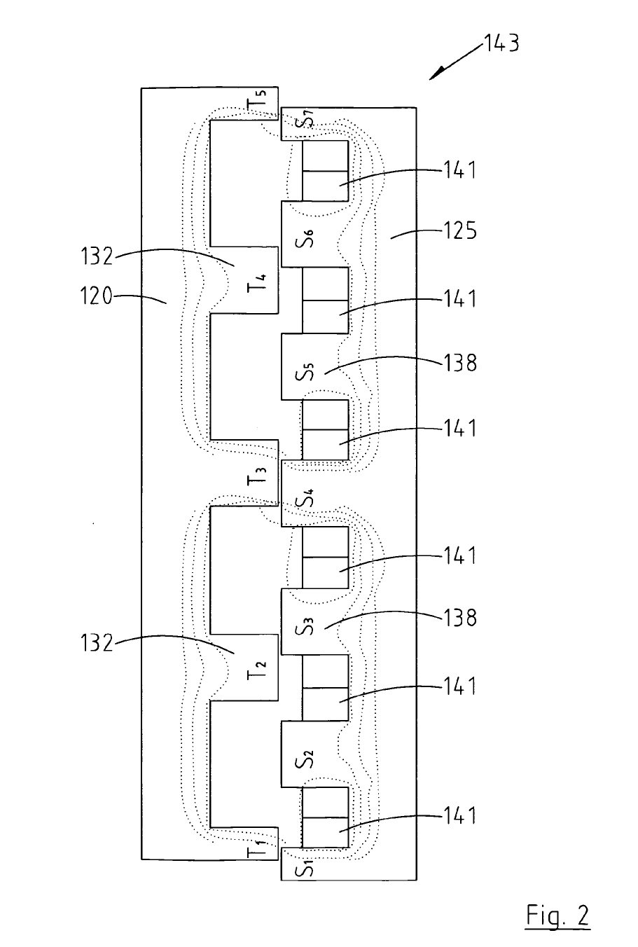

Referring now to FIG. 2 which shows a section 143 of a 6/4 linear switched reluctance generator 102. It will be appreciated by those skilled in the art that the generator 102 may comprise any number of such sections 143 or any specific configuration of individual sections. In this exemplary arrangement, every six stator poles 138 are opposite four translator poles 132. The translating member 120 reciprocates under the influence of the oscillating wave driven body 115 of the wave energy absorber 105. Stator poles S1, S4 and S7 are shown energised, driving magnetic flux in a closed loop through S1, T1, T3, S4 and back to S1. A similar closed flux loop is set up between S4, T3, T5 and S7. The magnetic flux in the air gaps 140 exerts a strong force pulling both the translating member 120 and the stator members 125 closer together horizontally, and also exerts a force vertically aligning the energised poles. The translating member 120 is urged against this force by the wave driven body 115 of the wave energy absorber 105 thereby converting the mechanical energy absorbed by the translating member 120 from the linkages of the wave energy absorber into electrical energy.

As the translator poles 132 moves further out of alignment, the alignment force on the energized poles T1, T3 and T5 weakens, and reaches a minimum when T3 is mid-way between S4 and S5. At this point the next translator pole T2 has moved into alignment with S3 and T4 has aligned with S6, so S1, S4 and S7 are de-energised, and S3 and S6 are energised. This drives flux across the air gap 140 through T2 and T4, exerting a backward alignment force as the translating member 120 moves past.

The mechanical power, Pₘ, absorbed by the translating member 120 from the wave energy absorber 105 is given approximately by:

Pₘ=F₌x (1)

Where: v is the velocity of the translating member 120, and Fe is the electromagnetic force exerted on it by the magnetic field.

Under generator operation the direction of Fₑ is opposite to the direction of motion of the translating member 120, so P<0.

The electromagnetic force Fₑ is a function both of the displacement of the translating member 120 and the coil currents iₐ, i_{b} and i_{c} Since the phase currents are turned on in turn, the total electromagnetic force can be found by considering a single phase ‘a’ only, with the assumption that phases ‘b’ and ‘c’ behave identically.

iJdLₐJx, U (2)

Where:

Las is the inductance of phase ‘a’, and is is the phase ‘a’ current.

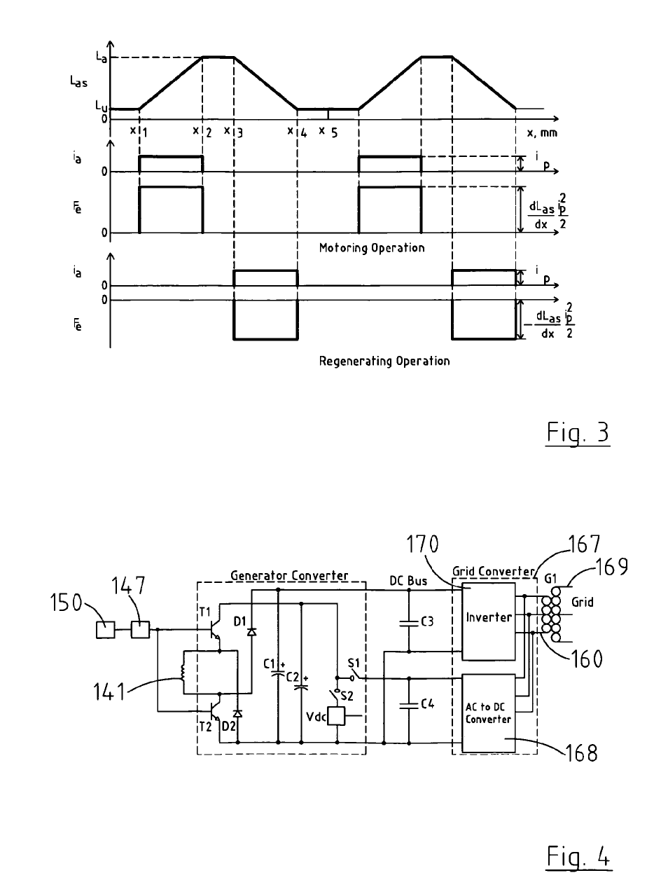

Referring now to FIG. 3, an inductance profile for one phase of the generator 102 is shown. The inductance is a maximum when poles 132, 138 are in full alignment and a minimum when poles 132, 138 are completely out of alignment. A six-pole generator 102 has three independently-driven phases each phase consists of a number of pairs of coils connected in series. The 6/4 generator 102 may therefore be considered as a three-phase machine. Under normal operation only one phase of the machine 102 is switched on at a time, energising all the coils 127 wrapped around the stator poles 138 in alignment with the translator poles 132, which, in this exemplary embodiment, is every third stator pole 132. The profiles of FIG. 3 assume an ideally square current waveform; in practice the maximum rate of rise and fall of the phase currents is finite, and depends on the phase inductances and resistances.

It will be appreciated that wave energy varies significantly depending on the conditions in the ocean. In periods of large swells, the wave energy absorber 105 generates a large amount of kinetic (mechanical) energy which drives the translating member 120 at a high speed so a large amount of electricity is generated. In periods of relatively small swells, the kinetic (mechanical) energy generated by the wave energy absorber 105 is significantly less than periods of large swells resulting in less kinetic energy and as a consequence the translating member 120 is driven at a slower speed resulting in less electricity being generated.

As will be discussed in greater detail below, to address this variance in the output of the electricity generated as a result of varying conditions, a control means provided by the control unit 147 regulates the electromagnetic force Fₑ and in turn the damping force of the translating member 120 by selectively energising the coils 141 with power from an on-shore electrical grid 169 (shown in FIG. 4) so that the velocity of the translating member 120 remains substantially constant irrespective of the ocean conditions. In this manner the operating characteristic of the generator 102 is dynamically varied to the prevailing ocean conditions (wave regime). If the generator 102 was not dynamically varied/tuned, the damping resistance of the translating member 120 would have to be set to cope with a wave regime which provides maximum wave energy. The generator 102 is a mechanical device with mechanical operating limitations, for example, the speed of the translating member 120 has to be within certain limits. If the speed of the translating member 120 exceeds these limits there is a significant risk that the generator 102 would malfunction due to its inability to cope with the excess kinetic energy provided by the wave absorber 105. The control unit 147 ensures that the speed of the translating member 120 operates within its design limits by varying the electromagnetic force Fₑ which in turn varies the damping resistance of the translating member 120. For example, in periods of large swells it is desirable that the aligning force between the poles 132, 138 is large enough to provide a large damping resistance to the wave driven body 115 or otherwise the translating member 120 may operate outside its speed limits resulting in the generator 102 malfunctioning. In periods of small swells it is desirable that the aligning force between the poles 132, 138 is relatively small to provide significantly less damping resistance to the wave driven body 115 than in periods of large swells so that the translating member 120 moves at a speed to maximise the amount of electricity being generated. If the electromagnetic force was not varied, in periods of small swells very little electricity would be generated.

Referring now to FIG. 4, an exemplary circuit diagram of a single phase of the switch reluctance generator 102 is shown. It will be appreciated that the coils 141 previously described as being wound around the respective stator poles 138 are coupled to a corresponding circuit as illustrated in FIG. 4. A power line 160 operably coupled to a mains electricity supply grid 169 relays AC power to a grid converter 167. It will be understood that the mains electricity supply grid 169 is remotely located to the operation of the wave energy absorber, i.e. it may be considered an on-shore arrangement whereas the wave energy absorber is an off-shore arrangement. The characteristics of the power line 160 are selected to be appropriate to effect a transfer of power from the grid 169 to the generator 102. These characteristics will depend on the distances between the generator 102 and the mains power supply and the voltage at which the power is provided.

The control unit 147 is in communication with the sensor 150 for reading the sensed velocity of the wave driven body 115. The control unit 147 is also electrically coupled to the bases of transistors T1 and T2 for switching on and off the transistors thereby dynamically varying the operating characteristic of the generator 102 in response to changes in velocity of the wave driven body 115. In this exemplary circuit which may be usefully employed, the coil 141 is coupled intermediate the pair of bipolar power transistors T1 and T2. A first free wheel diode D1 is coupled to a common node shared by the transistor T2 and the coil 141. A second free wheel diode D2 is coupled to a common node shared by T1 and the coil 141. The control unit 147 is operable for turning on/off transistors T1 and T2 so that the circuit can operate as a motor or a generator thus the circuit has two modes of operation. When transistors T1 and T2 are switched on the coil 141 is energised thereby drawing power from the grid 169 via the AC-DC inverter 168 of the grid converter 167. When the coil 141 is being energised in this fashion the circuit operates as a motor.

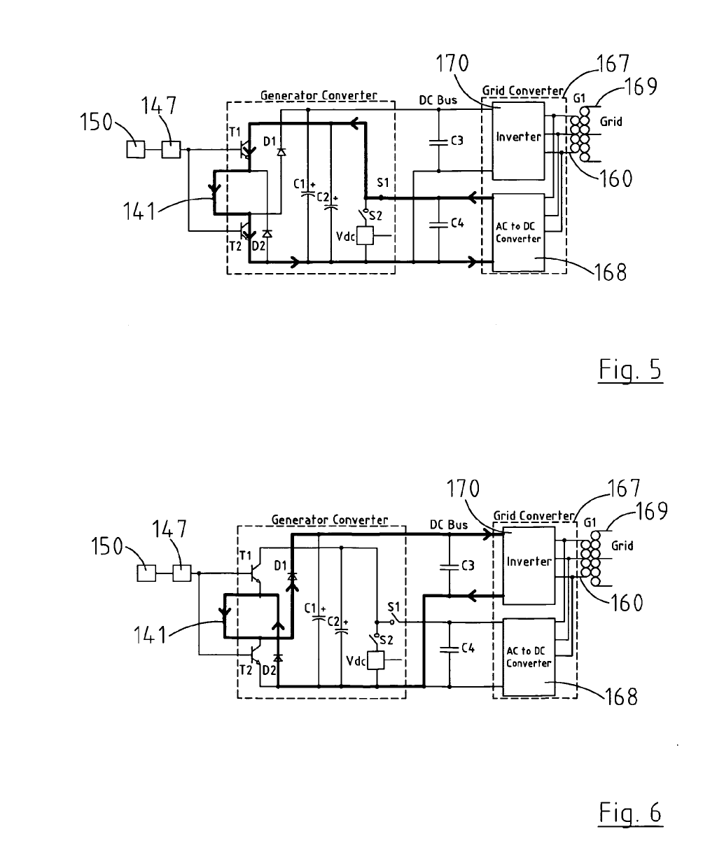

FIG. 5 diagrammatically illustrates power being drawn from the grid 169 when the transistors T1 and T2 are switched on. In contrast, when the transistors T1 and T2 are switched off the circuit operates as a generator providing power from the coil 141 to the grid 169 via the DC-AC converter 170 of the grid converter 167. FIG. 6 diagrammatically illustrates power being provided from the coil 141 to the grid 169 when the transistors T1 and T2 are switched off.

In operation, the generator 102 is operably coupled to the wave energy absorber 105. The submerged wave driven body 115 of the wave energy absorber 105 is forced to oscillate by wave energy, which in turn provides a driving force which drives the translating member 120 to reciprocate. The movement of the translating member 120 converts mechanical energy absorbed form the wave energy absorber 105 into electrical energy. The sensor 150 senses the velocity of the wave driven body 115 which is then read by the control unit 147.The control unit 147, in response to the velocity of the wave driven body 115, appropriately modulates the phase currents of the energy converter 102 for controlling the electromagnetic force Fₑ and in turn the damping resistance of the translating member 120. It will therefore be appreciated that the control unit 147 is co-operable with the sensor 150 for selectively controlling power from the electrical grid to the energy converter 102 thereby energising the converter 102 for varying its phase currents in response to the velocity of the wave driven body 115. This arrangement allows for reactive control in response to varying ocean conditions.

When the control unit 147 switches on transistors Ti and T₂ a current circulates in a phase of the generator 102, increasing in magnitude. When the current rises above a threshold value, transistors Ti and T₂ are switched off as illustrated in FIG. 6. The energy stored in the winding of coil 141 keeps the current flowing in the same direction, decreasing quickly in magnitude below the threshold level. The diodes Di and D₂ provide a path for the coil current to continue to flow, quickly decaying after Ti and T₂ turn off. It should therefore be apparent that the power transistors Ti and T₂ switch on and off many times during the excitation of a single phase. Modulating the phase current for changing damping resistance of the translating member 120 is achieved by increasing or decreasing the switching times of the power transistors Ti and T₂. It will be appreciated by those skilled in the art that other switching converters and switching strategies may be used as an alternative to the arrangement to that of FIG. 4. The circuit arrangement of FIG. 4 is given by way of example only and it is not intended to limit the invention to this arrangement.

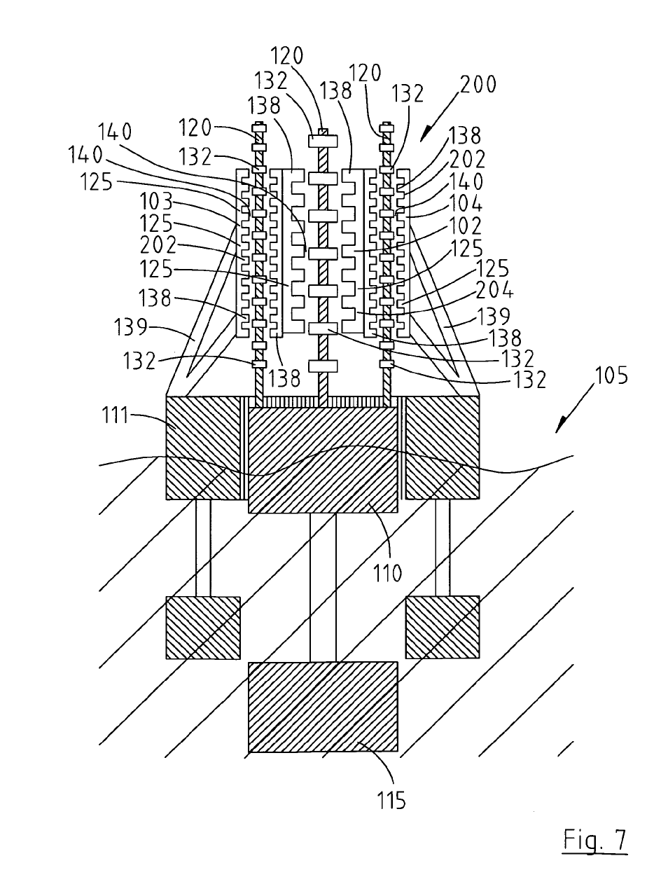

Referring now to FIG. 7 there is illustrated another embodiment of a wave energy conversion system 200 which is also in accordance with the present teaching. The system 200 of FIG. 7 is substantially similar to the system 100 of FIG. 1, and like components are indicated by similar reference numerals. The main difference is that the system 200 includes two additional side generators 202 operably coupled to a central generator 204. The two side generators 202 and the central generator 204 are provided in a modular arrangement for facilitating modular assembly. It is envisaged that the modular arrangement may include any desired number of generators and configuration. The two side generators 202 and the central generator 204 operate substantially similar to the generator 102 of FIG. 1. The dimensions (geometries) of the side generators 202 are less than that of the central generator 204 which facilitates fine tuning to the prevailing wave regime. The control means may activate or deactivate one or more generators of the modular arrangement when desired. The control means may also be configured so that only some of the coils 141 in a particular generator are energised while the other coils 141 of that generator 102 are not energised such an arrangement facilitate finely adjusting the parameters of the generator 102 to suit the prevailing wave regime. When desired the control means may selectively activate a combination of coils in a combination of generators. For example, four coils in one generator may be energised while six coils in the neighbouring generator may be energised, the two generators may have differing geometries.

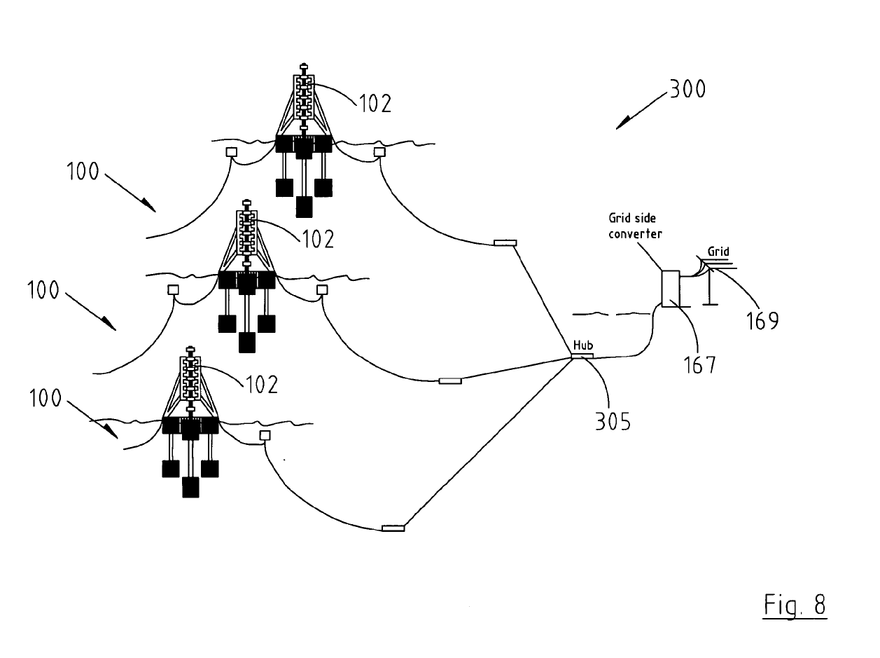

Referring now to FIG. 8 there is illustrated an off-shore distributed electrical network 300 which includes a plurality of wave energy conversion systems 100 and is also in accordance with the present teaching. The network 300 comprises a central hub 305 operably coupled to the off-shore grid 169 and the wave conversion systems 100 which facilitates duplexing of power between the grid 169 and the generators 102 as well as between the respective generators 102. The central hub 305 includes a control unit for controlling power to the generators 102 and may operate in a similar fashion to the control unit 147 of FIG. 4. The grid converter 167 is provided on-shore and the central hub 304 is provided off-shore. It is envisaged that the hub 305 may also be provided onshore. The generators 102 may be energised from power from the grid 169 or from at least one of the other generators 102 via the central hub 305. The electrical grid 169 is AC compatible and the generators 102 are DC compatible. The grid converter 167 provides a bridge between AC to DC, and vice versa. The arrangement of the central hub 305 allows for the combining of DC power generated by the individual generators 102 which is then converted to AC by the grid converter 167. It will therefore be appreciated that it is not necessary to provide complex DC-AC or AC-DC conversion circuitry for each generator 102 as they share a common grid converter 167.

The advantages of a system provided in accordance with the present teaching are many. In particular, the wave energy conversion system of the present application eliminates the need to use hydraulic/pneumatic circuits, thereby increasing efficiency as the mechanical energy is directly converted to electrical energy. Furthermore, the systems 100 and 200 can absorb and convert mechanical power in an irregular way and unsynchronised fashion which is particularly suitable for wave power generation. This converted mechanical energy may be coupled to an AC supply. The translating member 120 is robustly constructed from laminated electrical steel, with no copper coils, and is therefore suitable for the harsh environmental conditions which are commonplace of wave energy conversion systems. The coils 141 on the stator member 125 are easy to configure, as they are wound tightly around the stator poles 138. It will therefore be appreciated that complicated distributed coil arrangements, of the type found in synchronous and induction generators, are not required.

Furthermore, the generator 102 does not require permanent magnets in its construction. It is undesirable to include permanent magnets in a wave energy conversion system as they must be sized to accommodate the largest energy flux anticipated from the wave climate where the wave absorber is located, resulting in that the generator 102 is overrated for most of the time. Also permananet magnets are unsuitable as they are relatively expensive, suffer from demagnetization over time and have to be replaced periodically, and are prone to oxidation in hostile environments. By avoiding the use of permanent magnets these problems are avoided.

Both generating and motoring action are possible in both directions using unipolar current, simply by adjusting the switching sequence in the phase coils. Since mutual coupling is absent, each phase is electrically independent of the others. A short-circuit fault in one phase therefore has practically no effect on the operation of the other phases. This is in direct contrast to a permanent magnet synchronous machine, where a failure of one phase puts the machine out of action.

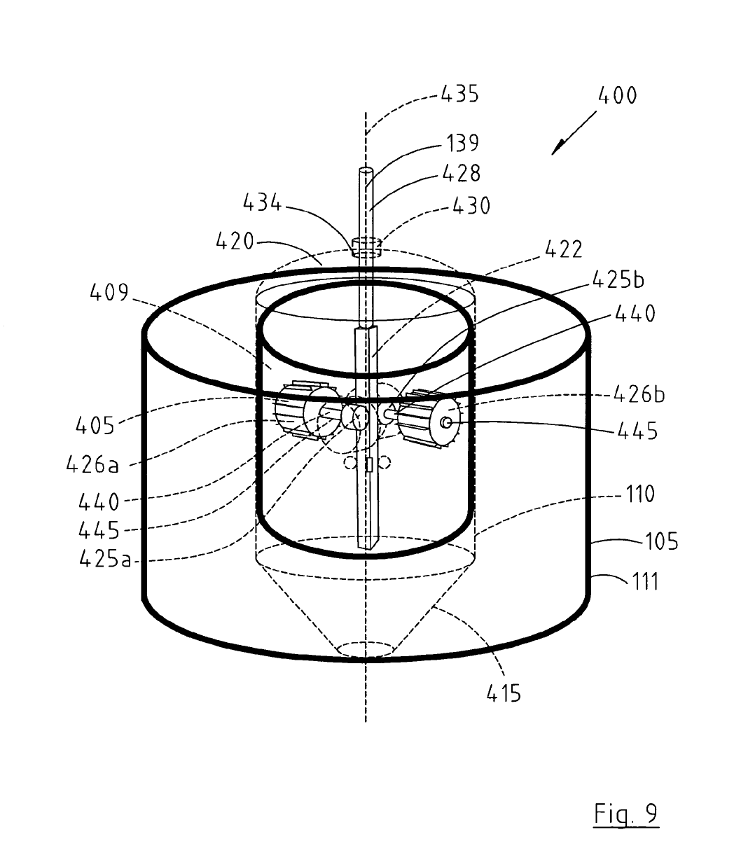

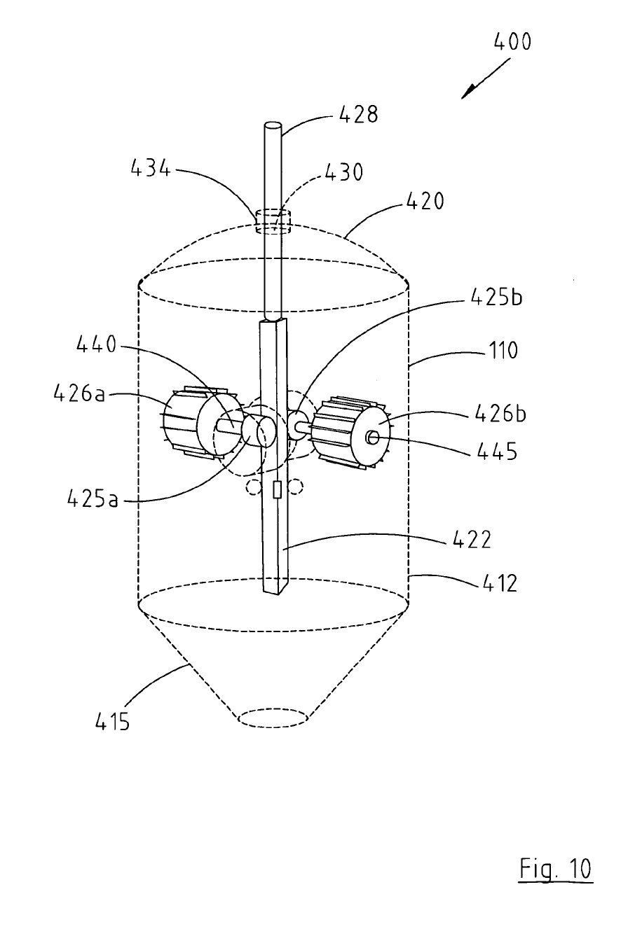

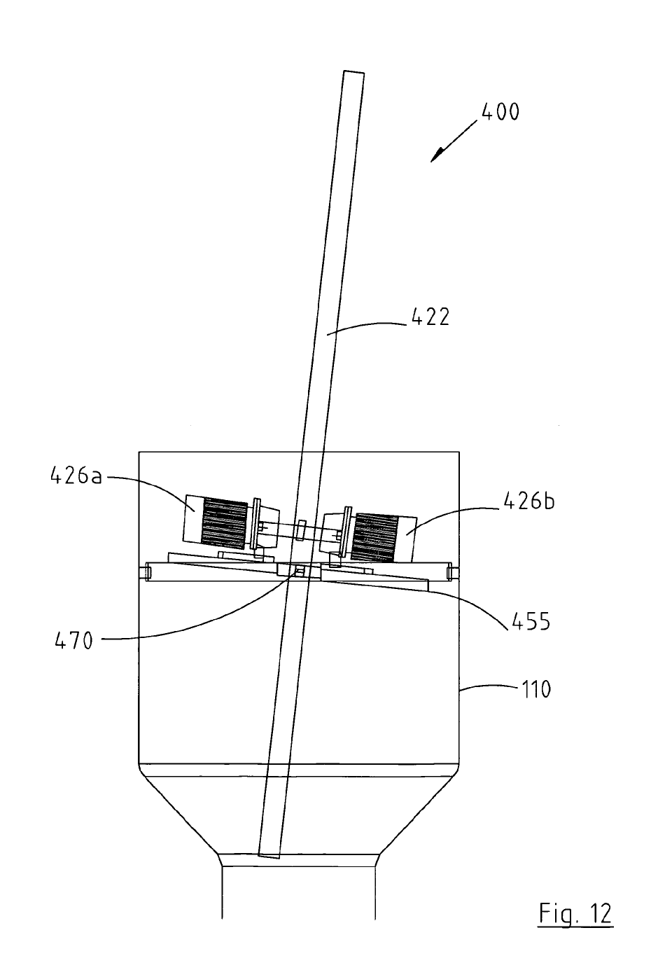

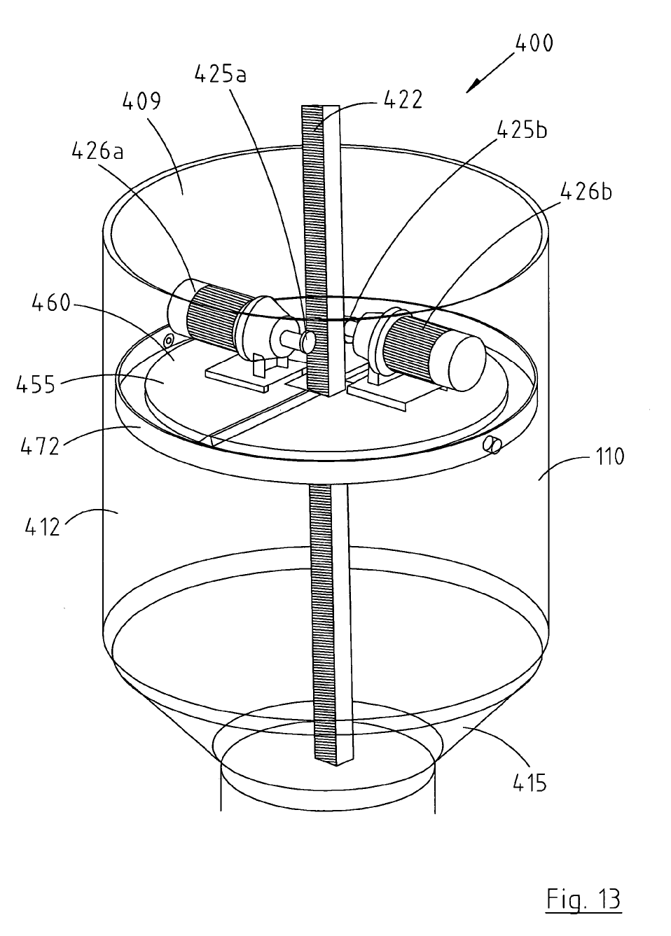

Referring now to FIGS. 9 to 13 there is illustrated another exemplary wave conversion system 400. The system 400 is substantially similar to the system 100 and like components are indicated by similar reference numerals. The main difference between the system 400 and the system 100 is that the switched reluctance machine is provided as a rotary switched reluctance generator 405. The generator 405 is operable to convert linear motion into rotary motion which is then converted into electrical energy. The rotary switched reluctance generator 405 is operably coupled to the on-shore electrical grid 169 in a similar fashion to the generator 102. The generator 405 is operable in a generating mode for providing power to the electrical grid 169 and a motoring mode for extracting power from the electrical grid. A control unit (not shown) is co-operable with a sensing means (not shown) for controlling the generator 405 to operate in one of the generating or motoring modes.

The inner float 110 of the wave absorber 105 defines an interior volume 409 in which the generator 405 is housed. In this example, the float 110 includes a central cylindrical portion 412 which terminates at one end thereof with a frustoconical portion 415 and the opposite end with a dome portion 420. The generator 405 comprises a translating mechanism in the form of an elongated rack 422 which operably drives a pair of pinions 425 which in turn drive corresponding switch reluctance motors 426. In the exemplary arrangement two motors 426 are provided but it will be appreciated that the present teaching is not to be construed as limited to such an exemplary arrangement. The control unit is in communication with the sensing means for sensing an operating parameter generated by the wave energy absorber. The operating parameter may include the velocity of the rack 422 but other parameters are also envisaged.

The rack 422 is operably coupled to the power take off linkages 139 that harness power as result of the inner float 110 and the torus 111 oscillating at different frequencies in response to passing waves. A translator 428 which forms part of the power take off linkages 139 reciprocates in response to the oscillations. Reciprocal movement of the translator 428 causes the rack 422 to also reciprocate. The pinions 425 operably engage respective opposite sides of the rack 422 and rotate in response to the longitudinal motion generated by the rack 422 reciprocating. The rack 422 extends through an aperture 430 formed on the inner float 110 such that a first portion of the translator 428 is located in the interior volume 409 and a second portion of the translator 428 is located externally of the interior volume 409. A seal 434 prevents sea water from entering the interior volume 409 while allowing the translator 428 to move axially through the aperture 430. The translator 428 defines a longitudinal axis 435 which is substantially co-axial with the longitudinal axis of the rack 422. Each pinion 425 and its associated switched reluctance motor 426 share a drive shaft 440 that defines a common axis of rotation 445. The common axis of rotation 445 is substantially perpendicular to the longitudinal axis 435.

The longitudinal axis of the rack 422 is aligned coaxially with the heave axis of the wave absorber 102. The rack 422 provides a plurality of individual teeth which are engageable with the pinions 425 so as to translate and transfer linear motion along the heave axis to rotational motion necessary for actuation of the motors 426. In the exemplary arrangement shown two separate pinions 425a, 425b are each coupled to the same rack 422—albeit to different surfaces, each of the difference surfaces comprising a set of teeth that are individually engageable with corresponding teeth on the pinions 425.

The wave conversion system 400 has many advantages. The diameters of the pinions 425 and the rotors of the switched reluctance generators 426 can be suitably sized to maximize the generation of rotary motion. Velocities are increased in proportion to the ratio of the diameters of the generators 426 and the pinions 425. It will be appreciated that some of the potential for increased velocity may usefully be offset by a reduction in stroke length. For example, if the ratio of diameter of the rotor to that of the pinion is 3:1 and the rack velocity is 1 m/sec as result of the relative velocity in heave between torus 111 and inner float 110, then the shear speed at the air gap between rotor and stator of the switch reluctance generator is 3 m/sec. Such speeds may be further increased by introducing a gearbox (eg an additional 3:1) and/or by using a non-standard switched reluctance machine, of similar capacity but with a shorter axle and larger rotor diameter.

One of the primary advantages is that the generators 426 are not in direct contact with the power take off linkages as the rack and pinion arrangement is operably coupled there between. The mechanical tolerances of the rack and pinion arrangement is significantly greater than those of the generators 426. Thus the rack and pinion arrangement is more robust than the generators 426. As a consequence, the rack and pinion arrangement is much better suited to coping with the translator 428 rocking from side to side as it reciprocates compared to the drive shafts 440 of the generators 426. As the translator 428 moves it may not travel along the exact same longitudinal path as the oscillating floats 110, 111 may cause it to sway. A major problem associated with wave energy converters where the power is recovered from the relative movement between two or more large oscillating bodies is the need to maintain the oscillating bodies in close alignment along the heave axis. This is especially important where the prime mover in the power take off is a hydraulic ram or a linear generator with one part attached to the torus (eg the stator) and the other to the float (eg the translating member). The need to maintain a consistently small air-gap over a few metres in energetic waves requires elaborate and very robust bearings. The present invention reduces the problem by removing the switched reluctance machine from directly interfacing with the wave absorber. Instead a rack and pinion arrangement interfaces directly with the wave absorber which can tolerate greater mechanical loads and relative movements than the switched reluctance machine.

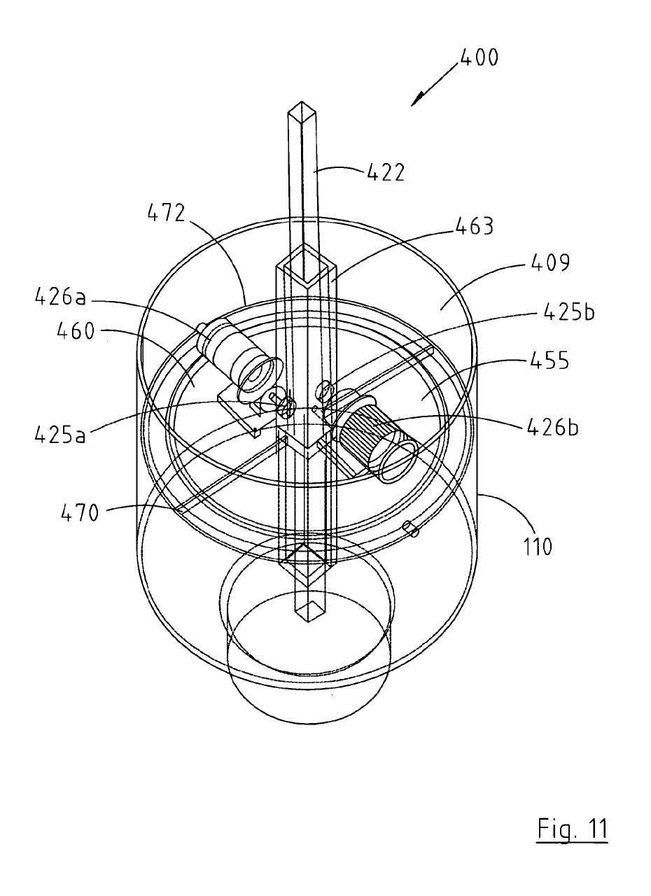

Referring now to FIGS. 11 to 13, in this exemplary embodiment the rotary generator(s) 426 are mounted on a moveable platform 455 within the interior volume 409 of the inner float 110. The platform 455 is rotatable relative to the longitudinal axis of the rack 422. In an optimum arrangement, a major surface 460 of the platform 455 on which the switched reluctance generators 426 are mounted is dynamically positioned to be at right angles to longitudinal axis of the rack 422. A portion of the rack 422 extends through a segment of box section 463. The box section 463 accommodates the pinions 425 therein so that their teeth mesh with the teeth on the rack 422. The box section 463 is mechanically arranged relative to the rack 422 so that it sways in tandem with the rack 422. In other words, if the rack 422 moves back and forth, the box section 463 also moves back and forth. However, it will be appreciated that the box section 463 does not reciprocate axially. A shaft 470 extends outwardly from the box section 463 to an annular member 472 and defines an axis of rotation on which the circular platform 455 pivots. The diameter of the annular member 472 is greater than the diameter of the platform 455 to allow the platform 455 to pivot in response to the rack 422 swaying from side to side. If the torus 111 and the inner float 110 are not aligned along the heave axis it may cause the rack 422 to sway. The moveable platform 455 is designed to track the rack 422 as it sways so the surface 460 is substantially perpendicular with the longitudinal axis of the rack 422. Such an arrangement greatly improves the overall sea worthiness of the wave energy conversion system 400 and reduces the need for the constraints to maintain alignment between the torus 111 and inner float 110.

It will be understood that what has been described herein are exemplary embodiments of a wave energy conversion system. While the present invention has been described with reference to an exemplary arrangement it will be understood that it is not intended to limit the teaching of the present invention to such arrangements as modifications can be made without departing from the spirit and scope of the present invention.

The words comprises/comprising when used in this specification are to specify the presence of stated features, integers, steps or components but does not preclude the presence or addition of one or more other features, integers, steps, components or groups thereof.

1. A wave energy conversion system, the system comprising:
a wave energy absorber configured to generate reciprocating motion from passing wave,
at least one switched reluctance machine including a translating mechanism being driven by the wave energy absorber for converting the reciprocating motion to electrical energy, the switched reluctance machine having a generating mode and a motoring mode,
a sensing means for sensing an operating parameter generated by the wave energy absorber, and
a control means being co-operable with the sensing means for controlling the mode of the switched reluctance machine in response to the sensed operating parameter.

2. A system as claimed in claim 1, wherein the switched reluctance machine comprises a rotary switched reluctance generator.

3. A system as claimed in claim 2, wherein the translating mechanism is configured for translating linear motion to rotary motion

4. A system as claimed in claim 31, wherein the translating mechanism is operably coupled to the wave absorber.

5. A system as claimed in claim 1, wherein the translating mechanism comprises a rack and pinion arrangement where at least one pinion operably engages a rack.

6. A system as claimed in claim 5, wherein the rack and pinion arrangement comprises a plurality of pinions arranged to operably engage a common rack.

7. A system as claimed in claim 6, wherein the rack and pinion arrangement comprises a pair of pinions which are arranged to engage respective opposite sides of the common rack.

8. A system as claimed in claim 6, wherein each pinion is arranged to drive at least one switched reluctance motor.

9. A system as claimed in claim 5, wherein the wave absorber comprises a float which defines an interior volume for housing the translating mechanism therein.

10. A system as claimed in claim 9, wherein the interior volume is sealed.

11. A system as claimed in claim 9, wherein the float comprises a central cylindrical portion.

12. A system as claimed in claim 11, wherein the central cylindrical portion terminates at one end thereof in a frustoconical portion.

13. A system as claimed in claim 12, wherein the central cylindrical portion terminates at the other end thereof in a dome portion.

14. A system as claimed in claim 9, wherein the wave absorber further comprises an outer torus which surrounds the float such that the torus and float define a two body oscillator.

15. A system as claimed in claim 14, wherein the wave absorber further comprises power take off linkages operably coupled to the two body oscillator.

16. A system as claimed in claim 15, wherein the linkages comprise a translator operably coupled to the rack for driving thereof.

17. A system as claimed in claim 16, wherein the translator defines a longitudinal axis which is substantially co-axial with a longitudinal axis of the rack.

18. A system as claimed in claim 17, wherein the pinion defines an axis of rotation which is substantially perpendicular to the longitudinal axis of the rack.

19. A system as claimed in claim 18, wherein the axis of rotation of the pinion is co-axial with an axis of rotation of the switched reluctance machine.

20. A system as claimed in claim 18, wherein the translator reciprocates when driven by the wave absorber which in turn causes the rack to reciprocate.

21. A system as claimed in claim 16, wherein the translator is dimensioned such that a first portion of the translator is located in the interior volume of the float and a second portion of the translator is located externally of the interior volume.

22. A system as claimed in claim 21, wherein the translator extends through an aperture formed on the float.

23. A system as claimed in claim 22, wherein the float comprises a sealing arrangement for sealing the aperture.

24. A system as claimed claim 23, wherein the sealing arrangement accommodates axial movement of the translator through the aperture.

25. A system as claimed in claim 17, wherein the switched reluctance machine in mounted on a moveable platform.

26. A system as claimed in claim 25, wherein the platform is moveable for positioning a major surface thereof relative to the longitudinal axis of the rack.

27. A system as claimed in claim 26, wherein the platform is pivotable for positioning a major surface thereof perpendicular with the longitudinal axis of the rack.

28. A system as claimed in claim 25, wherein the platform is rotatable about a shaft.

29. A system as claimed in claim 28, wherein the shaft defines an axis of rotation.

30. A system as claimed claim 5, wherein the sensing means is operable for sensing the velocity of the rack.

31. A system as claimed in claim 1, wherein the control means is configured to operably dynamically vary an operating characteristic of the switch reluctance machine.

32. A system as claimed claim 31, wherein the operating characteristic comprises an electromagnetic force characteristic.

33. A system as claimed in claim 1, wherein the switched reluctance machine comprises a linear switched reluctance generator.

34. A system as claimed in claim 33, wherein the linear switched reluctance generator comprises a moveable translating member for facilitating translating reciprocating motion into electrical energy.

35. A system as claimed in claim 34, wherein the translating member is configured for being driven by the wave energy absorber such that the translating member reciprocates in response to wave motion.

36. A system as claimed in claim 35, wherein the translating member comprises a plurality of translating poles.

37. A system as claimed in claim 36, wherein the translating member is elongated.

38. A system as claimed in claim 37, wherein the translating member comprises first and second set of translating poles, the first set of translating poles being provided on one of the sides of the translating member, and the second set of translating poles are provided on the opposite side of the translating member to the first set of translating poles.

39. A system as claimed in claim 36, wherein the translating poles are provided as teeth on the translating member.

40. A system as claimed in claim 39, wherein the teeth on the translating member are of rectangular cross section.

41. A system as claimed in claim 36, wherein the linear switched reluctance generator further comprises a pair of stator members, the translating member being arranged relative to the stator members so as to be moveable therebetween.

42. A system as claimed in claim 41, wherein two or more stator members are provided.

43. A system as claimed in claim 42, wherein each stator member comprises a plurality of stator poles.

44. A system as claimed in claim 43, wherein each stator member comprises at least one coil.

45. A system as claimed in claim 44, wherein a corresponding coil is wound on the respective stator poles.

46. A system as claimed in claim 43, wherein each stator member is elongated.

47. A system as claimed in claim 46, wherein the stator poles are provided as teeth on the stator member.

48. A system as claimed in claim 47, wherein the teeth on the stator member are of rectangular cross section.

49. A system as claimed in claim 47, wherein the translating member reciprocates relative to each stator member.

50. A system as claimed in claim 49, wherein the translating member is moveable intermediate a pair of spaced apart stators members.

51. A system as claimed in claim 43, wherein the translating poles and the stator poles define opposing pole arrangements.

52. A system as claimed in claim 51, wherein an air gap is provided between opposing translating poles and stator poles.

53. A system as claimed in claim 34, wherein the translating member is axially moveable.

54. A system as claimed in claim 1, wherein the switched reluctance machine comprises a plurality of generators.

55. A system as claimed in claim 54, wherein the geometries of at least two generators are different for facilitating varying the parameters of the switched reluctance machine in response to changes in the wave regime.

56. A system as claimed in claim 51, wherein the control means is configured to provide for selective activation of a combination of the generators.

57. A system as claimed in claim 56, wherein the control means selectively activates a combination of coils in the combination of generators.

58. A system as claimed in claim 1, wherein the switched reluctance machine is operably coupled to an electrical grid.

59. A system as claimed in claim 58, wherein when the switched reluctance machine provides power to the grid when operating in the generating mode and extracts power from the grid when operating in the motoring mode.

60. (canceled)

61. A wave energy conversion system, the system comprising:
a wave energy absorber comprising at least two bodies configured to move relative to one another in response to passing waves to generate mechanical energy,
at least one switched reluctance machine being driven by the wave energy absorber for converting mechanical energy to electrical energy, the machine having a generating mode and a motoring mode,
a sensing means for sensing an operating parameter generated by the wave energy absorber, and
a control means being co-operable with the sensing means for controlling the mode of the switched reluctance machine in response to the sensed operating parameter.

62. A wave energy conversion system operably coupled to a mains electrical grid, the system comprising:
a wave energy absorber for absorbing wave energy,
at least one mechanical energy converter being driven by the wave energy absorber for converting mechanical energy to electrical energy, the mechanical energy converter having a generating mode for providing power to the electrical grid and a motoring mode for extracting power from the electrical grid,
a sensing means for sensing an operating parameter of the wave energy absorber, and
a control means being co-operable with the sensing means for controlling the mode of the mechanical energy converter in response to the sensed operating characteristic of the wave energy absorber.
